(19) United States
(12) Patent Application Publication
(10) Pub. No.: US 2012/0032766 A1
(43) Pub. Date: Feb. 9, 2012

(54) Transformer for Communication Network

(76) Inventor: Ching-Wei Liang, Taipei County (TW)

(21) Appl. No.: 12/965,941

(22) Filed: Dec. 13, 2010

(30) Foreign Application Priority Data
Aug. 4, 2010 (TW) 099214873

(51) Int. Cl. H01F 27/02

(52) U.S. Cl. 336/90

(57) ABSTRACT

The transformer of the invention includes transformer windings, filter windings, pins, first bases, a second base and an insulative cover. The transformer windings and filter windings are mounted in each of the first bases and electrically connect to pins. The first bases with the transformer windings and the filter windings are mounted are mounted on the second base by inserting the pins into the second base. The insulative cover cloaks all of the components with exposing parts of the pins

### BACKGROUND OF THE INVENTION

1. Technical Field

The invention relates to transformers, particularly to transformers used in communication network.

2. Related Art

A transformer for communication network is a magnetic component between an interface of a terminal device and an Ethernet transceiver. These transformers have two kinds. The first kind is to be installed in RJ45 connectors, the second kind is to be soldered on circuit boards.

A typical transformer for being mounted on a circuit board is illustrated in FIGS. 1-3. Transformer windings 10 electrically connecting to filter windings 11 are put in an insulative cover 12. And the wires of the windings 10, 11 are connected with pins 13 of the insulative cover 12. The transformer windings 10 are installed in the insulative cover 12 after they have been connected with the filter windings 11. As a result, the connections between the windings 10, 11 and the pins 13 tend to be broken. Further, the insulative cover 12 does not a structure for supporting the windings 10, 11, so the connections between the windings 10, 11 and the pins 13 appear messy and are hard to be debugged. On the other hand, if a system or device requires larger-sized windings, the insulative cover 12 will be a limitation because it will occupy a larger area of a circuit board and is disadvantageous to the layout of circuit board.

### SUMMARY OF THE INVENTION

One object of the invention is to provide a transformer for communication network, which can vary the amount of transformer units depending on practical requirements and is advantageous to the layout of circuit board.

Another object of the invention is to provide a transformer for communication network, which can prevent the connections between the windings and pins from being broken.

Still another object of the invention is to provide a transformer for communication network, which can protect the windings.

To accomplish the above objects, the invention includes transformer windings, filter windings, pins, first bases, a second base and an insulative cover. The transformer windings and filter windings are mounted in each of the first bases and electrically connect to pins. The first bases with the transformer windings and the filter windings are mounted are mounted on the second base by inserting the pins into the second base. The insulative cover cloaks all of the components with exposing parts of the pins

### BRIEF DESCRIPTION OF THE DRAWINGS

FIG. 1 is a circuit diagram of the network transformer;

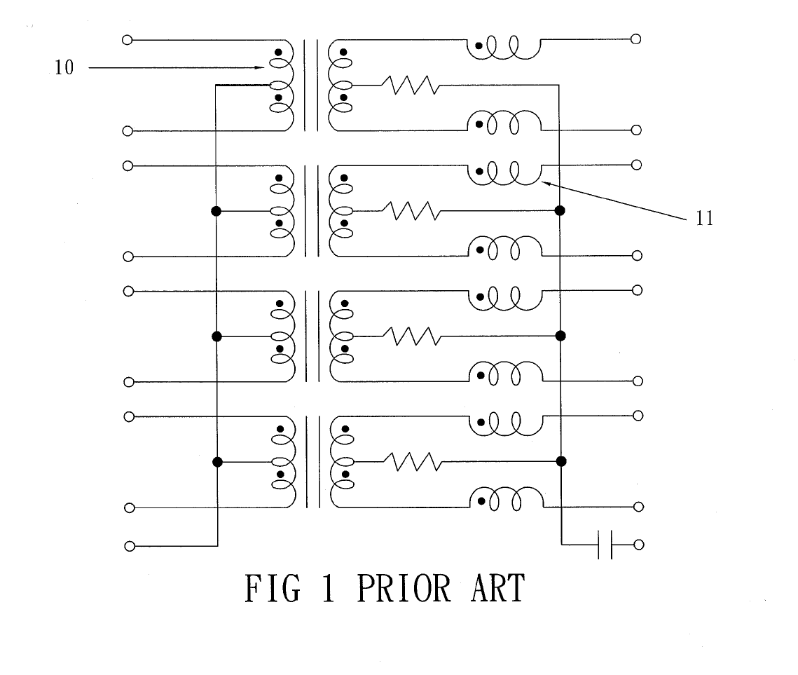

FIG. 2 is a schematic view of a transformer winding and a filter winding;

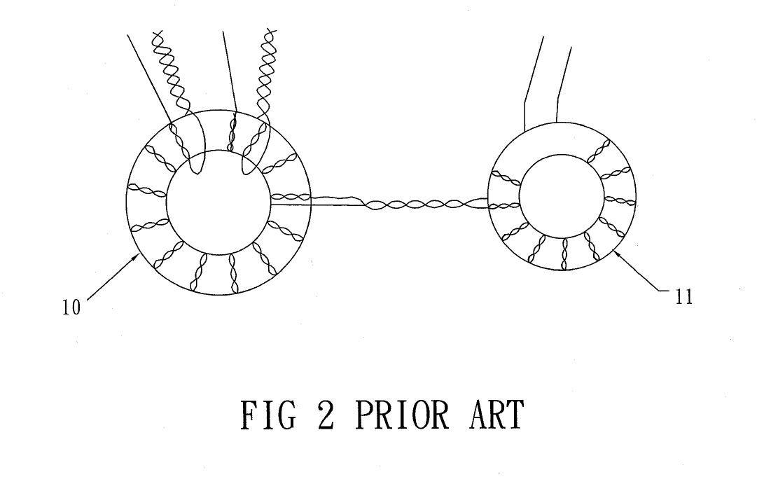

FIG. 3 is a perspective view of a conventional network transformer;

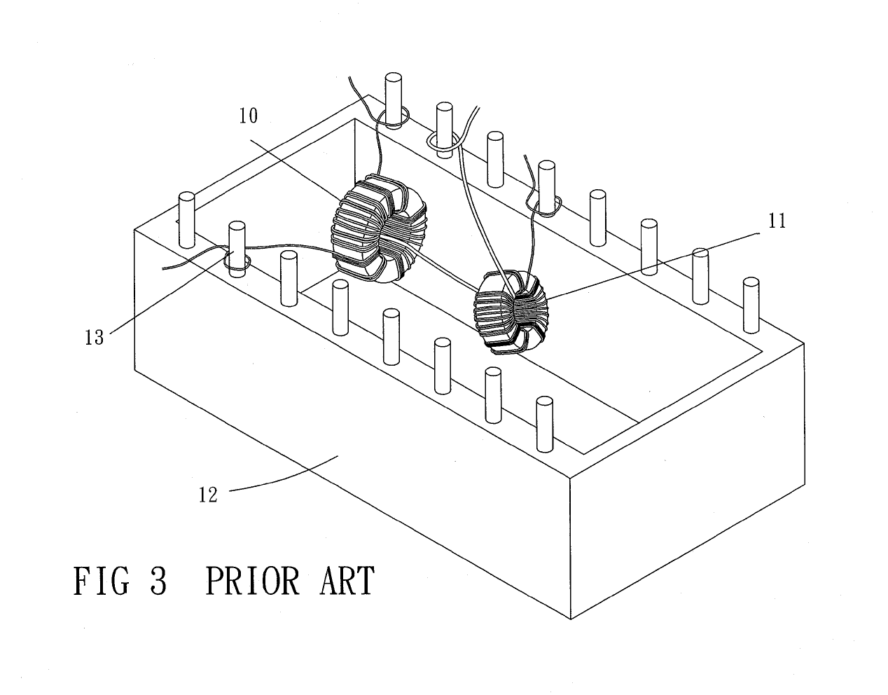

FIG. 4 is an exploded view of the transformer unit of the invention;

FIG. 5 is an assembled view of the transformer unit of the invention;

FIG. 6 is an exploded view of the transformer component of the invention;

FIG. 7 is an assembled view of the transformer component of the invention; and

FIG. 8 is a schematic view of the transformer component in association with a circuit board of an external device.

### DETAILED DESCRIPTION OF THE INVENTION

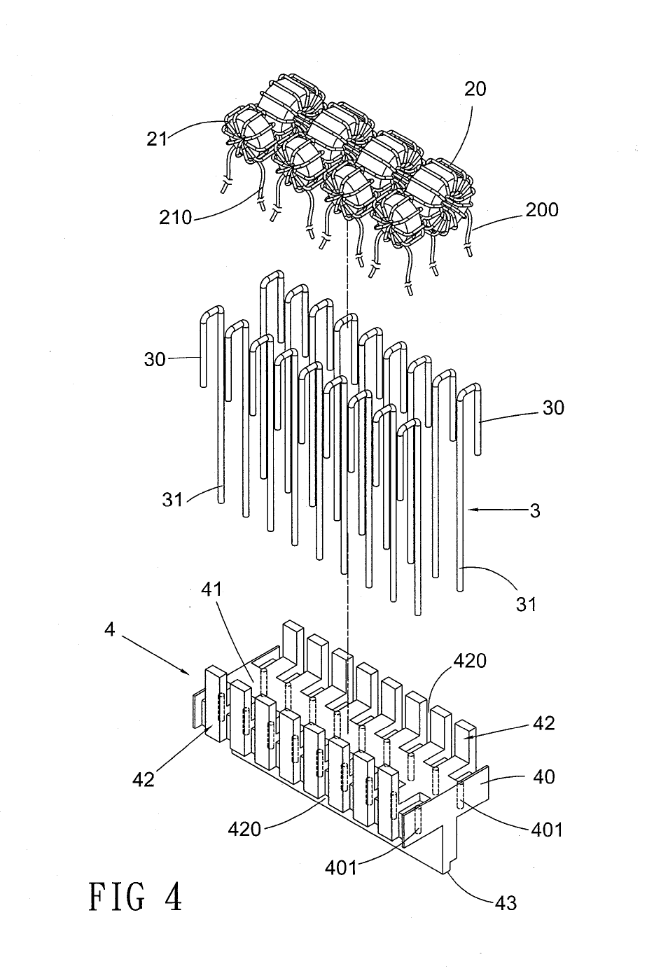

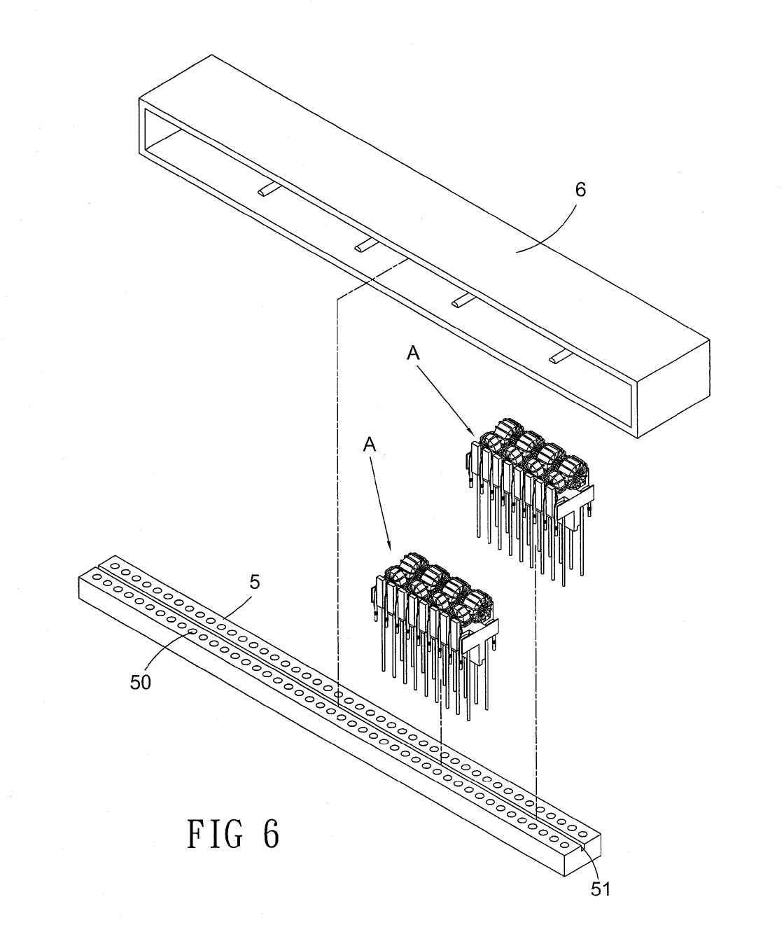

Please refer to FIGS. 4-6. The transformer of the invention includes transformer windings 20, filter windings 21, pins 3, first bases 4, a second base 5 and an insulative cover 6.

Each of the pins 3 has a connection portion 30 and a contact portion 31. The connection portions 30 are connected with wires 200, 210 of the transformer windings 20 or filter windings 21. The contact portions 31 are used for connecting with an external device.

The first bases 4 are made of an insulative material. Each of the first bases 4 has a body 40 with a space 41. The body 40 is provided with a plurality of positioning holes 401 separately corresponding to the pins 3, and the positioning holes 401 are separately passed through by the contact portions 31 of the pins 3. The space 41 accommodates the transformer windings 20 and the filter windings 21. The body 40 is formed with a positioning body 43 towards the second base 5.

The second base 5 is mounted by all of the first bases 4 and has a plurality of through holes 50 separately corresponding to the positioning holes 401 and a positioning trough 51 for being embedded by the positioning body 43.

The insulative cover 6 cloaks all of the above components with exposing a part of the contact portions of the pins 3.

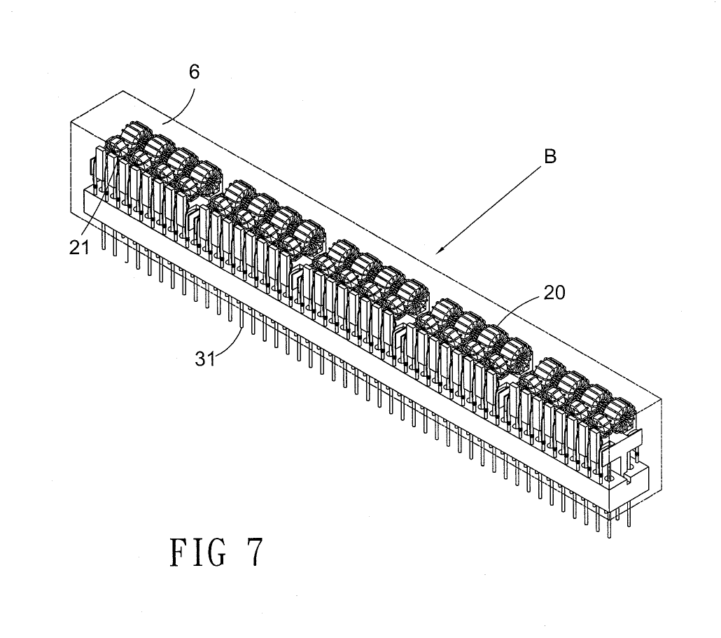

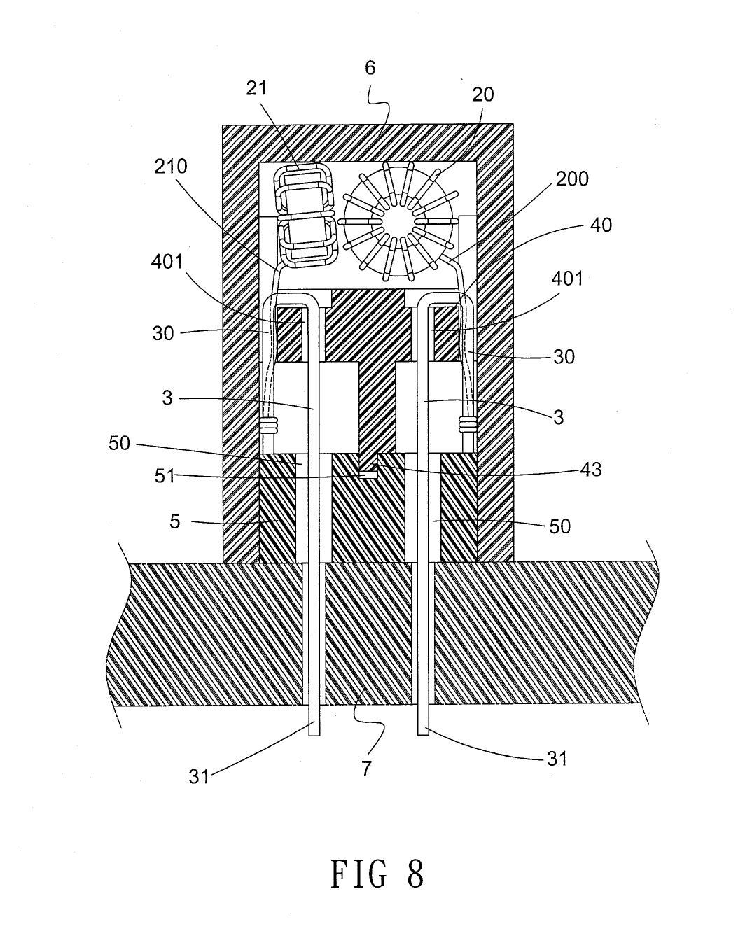

FIGS. 7 and 8 illustrate the assembling process of the invention. First, the pins 3 are inserted into the positioning holes 401 with exposing the connection portions 30 and contact portions 31. The connection portions 30 and the contact portions 31 may connect with the transformer windings 20 or the filter windings 21 and a circuit board 7 of an external device, respectively. Then, the transformer windings 20 and filter windings 21 are put in the space 41 of the first base 4. Next, every first base 4 which has assembled with the windings 20, 21 is mounted on the second base 5 by inserting the pins 3 into the through holes 50 with exposing the contact portions 31. That is, all the first bases 4 are gathered in a row. Finally, the insulative cover 6 is fastened to cloak all the components with protruding the contact portions 31. Thus, every the first base 4 including the transformer windings 20 and filter windings 21 is defined as an independent transformer unit A. Various amount of the transformer unit A may be gathered on the second base 5 depending on practical requirement. And the insulative cover 6 may package a plurality of transformer units A to be a single transformer component B. That is, a transformer component B including a plurality of the transformer windings 20 and filter windings 21 may be easily assembled. This can improve the yield rate.

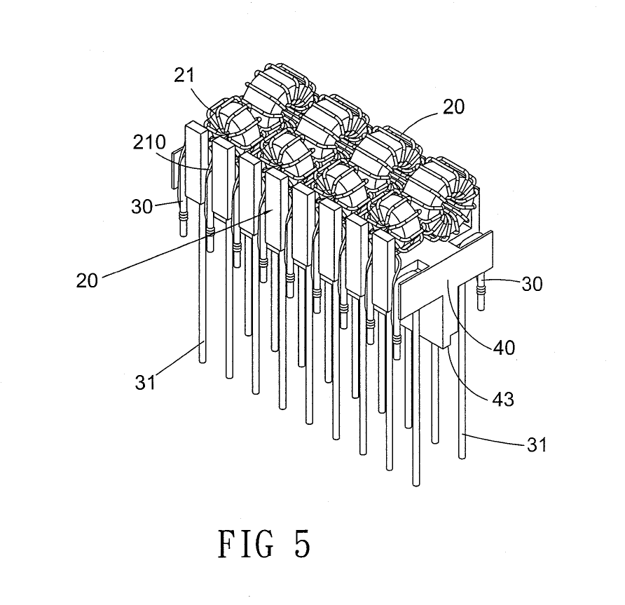

Please refer back to FIGS. 4 and 5. Two opposite sides of the body 40 of the first base 4 are separately formed with two side walls 42. The side walls 42 can prevent the transformer windings 20 and filter windings 21 from escaping out of the body 40. The side wall 42 is split by a plurality of gaps 420 for allowing the connection portions 30 to pass through. This is advantageous to connecting the wires 200, 201 because the wires 200, 201 may be positioned in respective gaps 420.

It will be appreciated by persons skilled in the art that the above embodiment has been described by way of example only and not in any limitative sense, and that various alterations and modifications are possible without departure from the scope of the invention as defined by the appended claims.

What is claimed is:

1. A transformer comprising:
a plurality of transformer windings;
a plurality of filter windings separately electrically connecting to the transformer windings;
a plurality of pins, each having a connection portion electrically connecting to the transformer windings or the filter windings and a contact portion for connecting with an external device;
a plurality of first bases, each having a body and a space accommodating the transformer windings and the filter windings, the body having positioning holes separately corresponding to the pins, and the positioning holes being separately passed through by the contact portions of the pins;
a second base, being mounted by all of the first bases, having a plurality of through holes separately corresponding to the positioning holes;
thereby the first bases assembled with the transformer windings and the filter windings are mounted on the second base by inserting the pins into the through holes.

2. The transformer of claim 1, further comprising an insulative cover for cloaking the second base and the first bases with the transformer windings and the filter windings.

3. The transformer of claim 1, wherein the body is formed with a positioning body towards the second base, and the second base is provided with a positioning trough for being embedded by the positioning body.

4. The transformer of claim 1, wherein two opposite sides of the body are separately formed with two side walls.

5. The transformer of claim 1, wherein the two side walls are split by a plurality of gaps for being passed by wires of the transformer windings or the filter windings.

6. The transformer of claim 5, wherein the wires are positioned in respective gaps.
